(19) United States
(12) Patent Application Publication
(10) Pub. No.: US 2026/0044867 A1
(43) Pub. Date: Feb. 12, 2026

(54) INTERNET OF THINGS DEVICE FOR PRODUCT DISTRIBUTION EQUIPMENT

(71) Applicant: PepsiCo, Inc., Purchase, NY (US)

(72) Inventors: Minjun HUANG, Valhalla, NY (US); Terry Tae-Il CHUNG, New Fairfield, CT (US)

(21) Appl. No.: 18/795,942

(22) Filed: Aug. 6, 2024

(51) Int. Cl. G06Q 30/0201; G06Q 10/067; G06Q 10/087; G16Y 20/10; G16Y 20/30; G16Y 40/10; G16Y 40/35

(52) U.S. Cl. CPC G06Q 30/0201; G06Q 10/067; G06Q 10/087; G16Y 20/10; G16Y 20/30; G16Y 40/10; G16Y 40/35

(57) ABSTRACT

A method of retrofitting a cooler includes installing a sensor suite on the cooler. The sensor suite includes monitors or monitoring systems such as a refrigeration system monitor, a traffic monitor, and a stock monitoring system. The method also includes installing a data module on the cooler. The data module is configured to store data acquired by the sensor suite.

### BACKGROUND

Conventional food and beverage coolers, such as those for use in retail locations, can be operated at very little cost in proportion to the revenue they bring to both goods manufacturers and store owners. The value that food and beverage coolers can bring to retail establishments is illustrated by consumers'willingness to pay higher prices for cooled goods than for the same goods stored at room temperature. Meanwhile, coolers can be manufactured, installed, and run at little expense. These factors have long made coolers popular among store owners and customers. As a result, many coolers are already installed globally, leading to a great volume of customer interactions with coolers every day, which can be expected to continue well into the future. Conventional coolers generally lack data capture capabilities that would enable these interactions to be measured and analyzed for the purposes of improving consumer experiences and providing business insight to manufacturers and store owners.

### BRIEF SUMMARY

A need exists for ways to collect data from coolers. Accordingly, aspects of the present disclosure are related to sensor suites that can be applied to coolers. In some embodiments, the sensor suites can be applied by retrofitting an existing cooler to include the sensors. In other embodiments, the sensor suites can be applied by including the sensor suites within coolers during the manufacture of the coolers. Whether the sensors are applied by retrofit or during original manufacture, the sensors can be implemented with a data module applied to the same cooler in the same way. Thus, in some embodiments, a cooler can be retrofitted to include a data module for the sensor suite, and in further embodiments, a cooler can be manufactured to include a data module for the sensor suite. In some embodiments, retrofit kits can be distributed, wherein each such retrofit kit includes a sensor suite and a data module. The sensor suite can include monitors such as, for example, a traffic monitor configured to detect a presence of individuals in a vicinity of the cooler, a door monitor configured to detect opening of a door of the cooler, a refrigeration system monitor configured to monitor performance of a refrigeration system of the cooler, and a stock monitoring system configured to monitor an amount of product stored in the cooler.

The data module can include a digital memory for storing information acquired by the sensors. The data module can also include one or more communications devices for communicating information from the memory to other devices. In various embodiments, the one or more communications devices can be configured for internet communication, for communication across local networks, or for direct communication to other computing devices. In any of the foregoing examples, the one or more communications devices can be configured for wired communication, wireless communication, or both wired and wireless communication.

Data acquired by the sensor suite and stored by the data module can be processed to derive optimizations for the usage of the cooler. The processing can be conducted by the data module, by remote computing devices to which the data module has transmitted the data acquired by the sensor suite, by human analysts, or by any combination of the foregoing. Processing taking place on the data module or any other computing devices can include the usage of a machine learning model. After the optimizations are implemented, further data can be acquired by the sensor suite and processed to derive further optimizations. Thus, an improvement cycle can include ongoing monitoring of the cooler, derivation of optimizations, and implementation of the optimizations. The derivation of optimizations can include aggregating data acquired by sensor suites in multiple coolers and deriving the optimizations from the aggregated data.

Some aspects of the present disclosure relate to a method of retrofitting a cooler. The method may comprise installing a sensor suite on the cooler. The sensor suite may comprise at least one selected from a group consisting of a refrigeration system monitor configured to monitor power usage by a refrigeration system of the cooler, a traffic monitor configured to detect presence of individuals in a vicinity of the cooler, and a stock monitoring system. The method may also comprise installing a data module on the cooler. The data module may be configured to store data acquired by the sensor suite.

In some embodiments according to the foregoing, the sensor suite may comprise a traffic monitor. The traffic monitor may comprise a radio frequency sensor.

In some embodiments according to any of the foregoing, the sensor suite may comprise a stock monitoring system. The stock monitoring system may comprise load cells.

In some embodiments according to any of the foregoing, installing the sensor suite may comprise configuring the load cells to measure load applied to shelves of the cooler.

In some embodiments according to any of the foregoing, installing the data module may comprise replacing a preexisting controller of the cooler with the data module.

In some embodiments according to any of the foregoing, replacing the preexisting controller of the cooler with the data module may comprise configuring the data module to assume control functions previously executed by the controller in the cooler.

Some aspects of the present disclosure relate to a method of optimizing usage of coolers. The method may comprise retrofitting multiple coolers according to any of the foregoing methods. The method may further comprise aggregating data stored on multiple of the data modules installed during the retrofitting of the multiple coolers. The method may further comprise deriving an optimization for the coolers from the aggregated data, wherein the optimization includes at least one of optimizing operating parameters of refrigeration systems of the coolers to maximize energy efficiency, optimizing schedules for restocking product in the coolers to maximize profit, and optimizing maintenance protocols for the coolers to minimize downtime of the coolers.

In some embodiments according to the foregoing, the method may comprise transmitting the optimization to at least one of the data modules.

In some embodiments according to any of the foregoing, the at least one of the data modules may be configured to execute control functions in at least one of the coolers.

In some embodiments according to any of the foregoing, the at least one of the data modules may be configured to alter operating parameters of the refrigeration system of the at least one of the coolers in accordance with the optimization.

In some embodiments according to any of the foregoing, the optimization may include an optimization of a planogram for the coolers to maximize a conversion rate of foot traffic in the vicinity of one of coolers to removal of product from the one of the coolers.

Some aspects of the present disclosure relate to a cooler retrofit kit. The cooler retrofit kit may comprise a sensor suite comprising at least two selected from a group consisting of a refrigeration system monitor configured to monitor power usage by a refrigeration system of the cooler, a traffic monitor configured to detect presence of individuals in a vicinity of the cooler, and a stock monitoring system. The retrofit kit may also comprise a data module configured to store data acquired by the sensor suite.

In some embodiments according to the foregoing, the data module may be configured to assume control functions of the cooler.

In some embodiments according to any of the foregoing, the sensor suite may comprise the stock monitoring system and the stock monitoring system may comprise load cells.

In some embodiments according to any of the foregoing, the data module may host a machine learning model configured to derive an optimization for usage of the cooler from data acquired from by the sensor suite.

In some embodiments according to any of the foregoing, the optimization may include an optimization of a planogram for the coolers to maximize a conversion rate of foot traffic in the vicinity of one of coolers to removal of product from the one of the coolers.

Some aspects of the present disclosure relate to a cooler. The cooler may comprise a sensor suite. The sensor suite may comprise a traffic monitor configured to detect presence of individuals in a vicinity of the cooler. The sensor suite may also comprise a stock monitoring system. The cooler may also comprise a data module configured to store data acquired by the sensor suite and to execute control functions in the cooler.

In some embodiments according to the foregoing, the data module may host a machine learning model configured to derive an optimization for usage of the cooler from data acquired from by the sensor suite.

In some embodiments according to any of the foregoing, the cooler may be configured to transmit the data acquired by the sensor suite to a remote device, receive optimizations from the remote device, and implement the optimizations through the execution of the control functions.

In some embodiments according to any of the foregoing, the cooler may comprise a refrigerated storage compartment and shelves located within the storage compartment. The stock monitoring system may comprise load cells configured to measure load on the shelves.

Additional embodiments and advantages of the disclosure will be set forth, in part, in the description that follows, and will flow from the description, or can be learned by practice of the disclosure.

It is to be understood that both the foregoing summary and the following detailed description are exemplary and explanatory only, and do not restrict the scope of the claims.

### BRIEF DESCRIPTION OF THE DRAWINGS

FIG. 1 is an oblique perspective view of a cooler according to an aspect of the present disclosure.

FIG. 2 is a schematic representation of a data module according to an aspect of the present disclosure.

FIG. 3 is a flowchart of an improvement cycle according to an aspect of the present disclosure.

FIG. 4A is a diagram of a system according to an aspect of the present disclosure.

FIG. 4B schematically illustrates an intelligent distribution system according to an aspect of the present disclosure.

FIG. 4C is a diagram of an analytic framework according to an aspect of the present disclosure.

### DETAILED DESCRIPTION

The present invention will now be described in detail with reference to embodiments thereof as illustrated in the accompanying drawings. References to “one embodiment,” “an embodiment,” “an example embodiment,” “some embodiments,” etc., indicate that the embodiment described may include a particular feature, structure, or characteristic, but every embodiment described may not necessarily include that particular feature, structure, or characteristic. Similarly, other embodiments may include additional features, structures, or characteristics. Moreover, such phrases are not necessarily referring to the same embodiment. When a particular feature, structure, or characteristic is described in connection with the embodiment, it is submitted that it is within the knowledge of one skilled in the art to effect such feature, structure, or characteristic in connection with other embodiments whether or not explicitly described.

The terms “invention,” “present invention,” “disclosure,” or “present disclosure” as used herein are non-limiting terms and are not intended to refer to any single embodiment of the particular invention but encompasses all possible embodiments as described in the application.

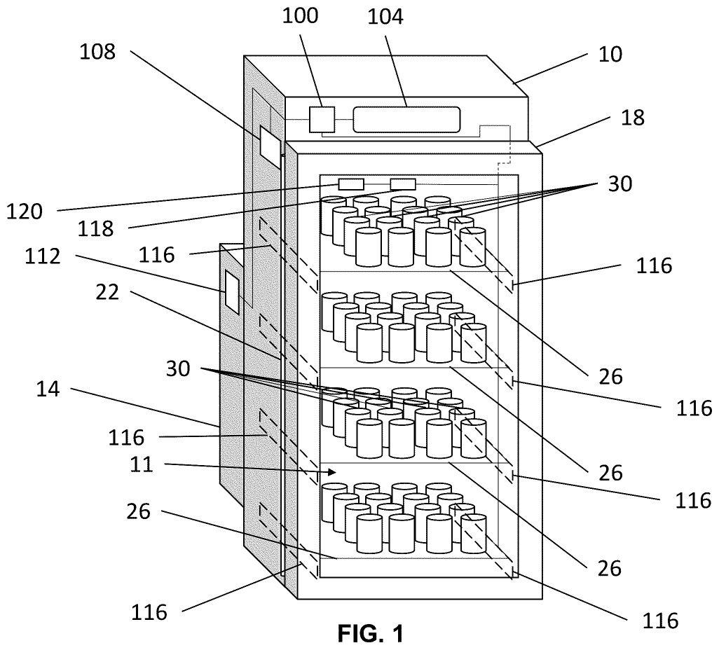

FIG. 1 illustrates a cooler 10 with a data module 100 installed therein. Data module 100 can be in communication with one or more sensors distributed within cooler 10.

Cooler 10 can include a storage compartment 11. Storage compartment 11 may be refrigerated. Thus, items such as products 30 can be kept at a low temperature when stored in storage compartment 11. Cooler 10 can further include shelves 26 within storage compartment 11 to facilitate accessible arrangement of product 30 within storage compartment 11.

Cooler 10 can also include a door 18. Door 18 can be configured to close off storage compartment 11 to reduce the flow of cooled air out of storage compartment 11 and of ambient air into storage compartment 11. Door 18 of the illustrated embodiment comprises a transparent panel making storage compartment 11 visible from outside cooler 10 when door 18 is closed, but the transparent panel is optional and may be omitted in other embodiments. Door 18 can be opened by a user to enable access to storage compartment 11, such as for the purpose of retrieving product 30 from storage compartment 11 or restocking storage compartment 11 with more product 30. Since most customer interactions with cooler 10 tend to be retrieval of product 30 from storage compartment 11, and customer interactions with cooler 10 tend to outnumber instances of restocking, quantity and frequency of customer interactions with cooler 10 can be roughly estimated by monitoring instances of door 18 being opened or closed.

Instances of door 18 being opened or closed can be detected from activity at a point of connection between door 18 and other parts of cooler 10. Cooler 10 of the illustrated embodiment includes a hinge 22 providing the connection between door 18 and other parts of cooler 10. Thus, instances of door 18 of the illustrated embodiment being opened or closed can be detected from activity of hinge 22. In further embodiments, cooler 10 can comprise other elements connecting door 18 to other parts of cooler 10 in addition to or instead of hinge 22, such as a latch or a track along which door 18 can slide. Activity of such other elements can also be monitored for the purpose of detecting opening or closing of door 18 and estimating the frequency or quantity of customer interactions with cooler 10.

Cooler 10 of the illustrated embodiment includes a door monitor 108 configured to detect when door 18 opens. Data module 100 is in electronic communication with door monitor 108 and any sensors included by door monitor 108. Thus, data module 100 can collect information acquired by sensors included by door monitor 108. In some embodiments, door monitor 108 can include at least one sensor, the at least one sensor including any one or any combination of an optical motion sensor, a mechanical displacement sensor, electrical contacts configured to move into or out of contact when door 18 opens, or any other type of sensor configurable to detect opening of door 18. Data captured by door monitor 108 can be used to estimate information such as, for example, a number of customer interactions with cooler 10 within a given timeframe or a frequency of customer interactions with cooler 10 within a given timeframe. Data captured by door monitor 108 can also be used in combination with data acquired by a stock monitoring system including load cells 116 or camera 118 as described below to facilitate tracking of stock of product 30 within cooler 10. For example, changes in a stock quantity of product 30 in cooler will frequently coincide with opening of door 18 for the purpose of withdrawing product 30 from cooler 10 or restocking cooler 10 with more product 30. Thus, times of openings of door 18 can be cross-referenced with changes detected in any information acquired by the stock monitoring system to improve detection of removal of product 30 from cooler 10 or discover restocking schedules. Given the ubiquity of coolers, valuable sales data can be collected to indicate, among other things: (1) what items sell well and which items do not; (2) sales associated with geographic locations, as well as specific retail outlets; and (3) fluctuations in sales data associated with one or more products. This sales data can be linked with sales, marketing, and inventory management systems.

Cooler 10 of the illustrated embodiment includes a refrigeration system 14.

Refrigeration system 14 can be configured to cool air in storage compartment 11. Refrigeration system 14 can include, for example, an evaporator, a compressor, a condenser, and an expansion valve arranged in a refrigeration cycle, along with a fan configured to direct air past the evaporator.

Cooler 10 of the illustrated embodiment includes a refrigeration system monitor 112 configured to monitor activity of refrigeration system 14. Data module 100 is in electronic communication with refrigeration system monitor 112 and any sensors included by refrigeration system monitor 112. Thus, data module 100 can collect information acquired by sensors included by refrigeration system monitor 112. Refrigeration system monitor 112 can include at least one sensor. The at least one sensor can be, for example, a sensor configured to measure power usage by refrigeration system 14.

Cooler 10 of the illustrated embodiment further comprises a temperature sensor 120 configured to measure air temperature within storage compartment 11. Data module 100 is in electronic communication with temperature sensor 120, and can therefore collect information acquired by temperature sensor 120. In the illustrated embodiment, temperature sensor 120 is located within storage compartment 11. In some embodiments, refrigeration system 14 performance can be estimated from patterns in the change of temperature of air within storage compartment 11. Thus, temperature sensor 120 can be used to monitor activity of refrigeration system 14. In some embodiments, temperature sensor 120 can be used in cooperation with refrigeration system monitor 112 to monitor refrigeration system 14. In further embodiments, either temperature sensor 120 or refrigeration system monitor 112 may be omitted, while the other of the temperature sensor 120 and refrigeration system monitor 112 may be included in cooler 10 and relied on to monitor activity of refrigeration system 14.

Cooler 10 of the illustrated embodiment includes a traffic monitor 104. Traffic monitor 104 is configured to detect a presence of individuals in a vicinity of cooler 10. Thus, traffic monitor 104 can be configured to monitor foot traffic in the vicinity of cooler 10. A vicinity of a cooler 10 can include an area within a predetermined distance from a cooler 10 within line-of-sight of the cooler 10. Thus, an individual can be within a vicinity of a cooler 10 if the individual is at a position within the predetermined distance from cooler 10 from which the individual can see the cooler 10. The predetermined distance can depend on the sensing capabilities of traffic monitor 104. The predetermine distance can be, in various examples, three feet from cooler 10, five feet from cooler 10, ten feet from cooler 10, 15 feet from cooler 10, or any other distance from cooler 10. Data module 100 is in electronic communication with traffic monitor 104 and any sensors included by traffic monitor 104. Traffic monitor 104 can be configured to acquire information usable to estimate quantities such as how frequently people pass near cooler 10 and how many times people pass near cooler 10 within a given timeframe. Traffic monitor 104 can include at least one sensor. The at least one sensor including either or both of a motion sensor and a radio frequency sensor. The motion sensor can be, for example, an optical motion sensor configured for the detection movement near cooler 10 based on changes in light reaching traffic monitor 104. The radio frequency sensor can be configured to detect nearby devices engaged in radio frequency communication, such as cellular devices and portable smart devices. Because many people carry such devices on their person, data acquired by the radio frequency sensor can be used to estimate a number of people that pass near cooler 10 within a given timeframe.

Cooler 10 of the illustrated embodiment includes a camera 118. Data module 118 is in electronic communication with camera 118. Thus, data module 100 can collect information acquired by camera 118. Camera 118 is configured to acquire images of an interior of storage compartment 11. In some embodiments, data module 100 may be configured to process images acquired by camera 118 to identify product 30 located within storage compartment 11. In further embodiments, images acquired by camera 118 can be communicated by data module 100 to another computing device 140 to be processed to identify product 30 located within storage compartment 11. In some embodiments, including some embodiments wherein data module 100 processes images acquired by camera 118 to identify product 30 and some embodiments wherein another computing device 140 processes images received from data module 100 to identify product 30, the images may further be processed to identify a quantity of product 30 within storage compartment 11. Thus, images acquired by camera 118 may be used to monitor inventory levels within storage compartment 11. In some further embodiments, the images may further be processed to identify a location of product 30 within storage compartment 11. Thus, images acquired by camera 118 may be used to monitor compliance with a planogram assigned to cooler 10. Any planograms mentioned herein may be product arrangement planograms. Product arrangement planograms can be specifications of what types and quantities or product 30 can be stored on cooler 10 and how products 30 of specific types should be placed within storage compartment 11. Camera 118 is generally referred to above and illustrated in FIG. 1 as being singular, but cooler 10 of some embodiments can include a plurality of cameras 118 directed into storage compartment 11 and configured to collectively acquire image data usable to monitor product 30 quantity, product 30 location, or both within storage compartment 11.

In some embodiments, camera 118 can be configured to capture image data of door 18. In some such embodiments, data module 100 may be configured to process the image data of door 18, such as by use of processor 136 described below, to detect condensation on door 18. In other embodiments, the image data can be communicated to other devices 140 by data module 100, such as by use of communication device 124 described below, and the image data can be processed by the other devices 140 or considered by a human reviewer to detect condensation on door 18. Condensation on door 18 can result from dysfunction of refrigeration system 14, so camera 118 according to some embodiments can assist with predicting when maintenance of refrigeration system 14 may become necessary.

Cooler 10 of the illustrated embodiment includes both a camera 118 and load cells 116. Information acquired by the camera 118 and load cells 116 can therefore be used together to monitor inventory levels of product 30 within storage compartment 11 in the illustrated embodiment. However, in other embodiments, cooler 10 may lack either or both of camera 118 and load cells 116. For example, cooler 10 according to some embodiments includes load cells 116 configured to measure load upon shelves 26, but lacks any camera 118 directed into storage compartment 11. Thus, information acquired by load cells 116 alone can be used to monitor inventory levels of product 30 within storage compartment 11. In another example, cooler 10 according to some embodiments includes at least one camera 118 directed into storage compartment 11, but lacks any load cells 116 configured to measure load upon shelves 26. Thus, cooler 10 can include a stock monitoring system that, in various embodiments, includes either or both of a camera 118 directed into storage compartment 11 and load cells 116 configured to measure load upon shelves 26 within storage compartment 11. As noted above, usage of a camera 118 within the stock monitoring system can, in some embodiments, enable monitoring of planogram compliance. Further, inclusion of both camera 118 and load cells 116 can, in some embodiments, enable more accurate and reliable monitoring of a quantity of product 30 within storage compartment 11 than using only camera 118 or only load cells 116 for stock monitoring. However, load cells 116 according to some embodiments can be less expensive than a camera 118 or plurality of cameras 118 capable of capturing sufficient image data to enable stock monitoring. Moreover, in some embodiments, load cell 116 data usable for stock monitoring can require significantly less memory to store than image data sufficient to enable stock monitoring of similar accuracy. Thus, in applications where installation cost or memory capacity may be a limiting factor, embodiments wherein cooler 10 includes load cells 116 but lacks any stock monitoring camera 118 can be advantageous. Given the low costs or acquiring and installing load cells, embodiments wherein cooler 10 includes load cells 116 can also be advantageous where minimizing cost is at a premium. Embodiments wherein cooler 10 includes load cells 116 can also be advantageous when seeking to use less energy.

Cooler 10 can include at least one load cell 116 configured to measure load on a shelf 26. In further embodiments, cooler 10 can include at least one load cell 116 for each shelf 26, with each load cell 116 being configured to measure load on a respective shelf 26. For the purposes of cooler 10, the load on a shelf 26 will be the total weight of the items, such as product 30, resting on the shelf 26. For each shelf 26 provided with at least one load cell 116, cooler 10 can include as many load cells 116 as needed to determine a total load on the shelf 26. Thus, in embodiments wherein a shelf 26 is connected to an interior of storage compartment 11 at multiple load bearing points, cooler 10 may include multiple load cells 116 collectively configured to measure a total load applied by the shelf 26 to all of the load bearing points. For example, as shown in FIG. 1, cooler 10 can include at least two load cells 116 for each shelf 26 configured to cooperate to measure total load on the shelf 26. In other embodiments, cooler 10 may instead include only one load cell 116 associated with each shelf 26, wherein each of the load cells 116 is configured to measure total load applied by a respective shelf 26 to all of the load bearing points for that shelf 26. In further embodiments, cooler 10 may include any plural number of load cells 116 associated with each shelf 26. In some embodiments, load upon a shelf 26 can be derived by measuring the total load applied by the shelf 26 to all load bearing points where the shelf 26 is connected to an interior of storage compartment 11 and subtracting the weight of the shelf 26 itself.

Data acquired by the various sensors and monitors of cooler 10 can be used together to estimate customer conversion rates. For example, data acquired by traffic monitor 104 can be analyzed together with data acquired by door monitor 108 to estimate a conversion rate of foot traffic in the vicinity of cooler 10 to opening door 18. Data acquired by door monitor 108 can be analyzed together with data acquired by the stock monitoring system to estimate a conversion rate of opening door 18 to removal of product 30 from cooler 10. Data acquired by traffic monitor 104 can be analyzed together with data acquired by the stock monitoring system to estimate a conversion rate of foot traffic in the vicinity of cooler 10 to removal of product 30 from cooler 10. The foregoing estimations may be possible in embodiments wherein the stock monitoring system includes load cells 116, embodiments wherein the stock monitoring system includes camera 118, and embodiments wherein the stock monitoring system includes load cells 116 and camera 118.

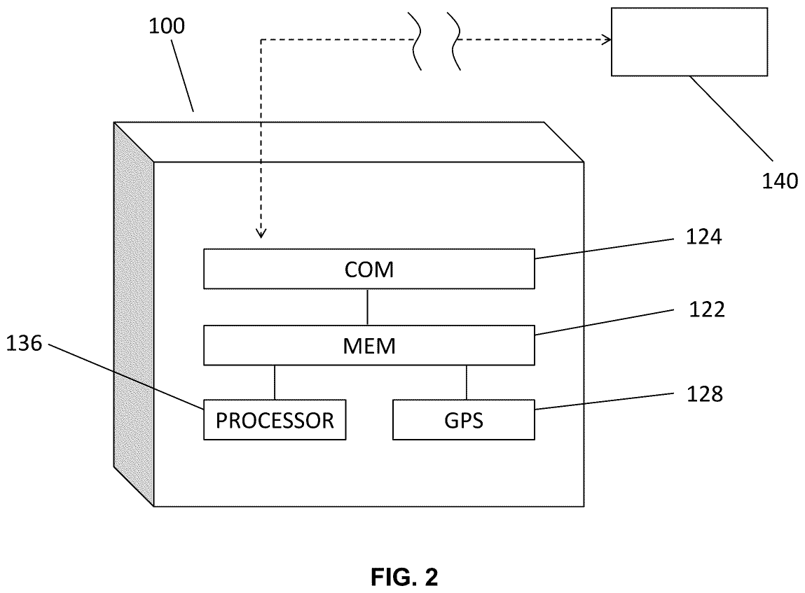

As shown in FIG. 2, data module 100 of the illustrated embodiment includes a memory 122. Data module 100 can be configured to use memory 122 to store information received from any sensors, monitors, or other devices with which data module 100 is in electronic communication. Thus, data module 100 of the illustrated embodiment can be configured to use memory 122 to store information received from traffic monitor 104, door monitor 108, refrigeration system monitor 112, load cells 116, camera 118, and temperature sensor 120.

Data module 100 also includes a communication device 124 in electronic communication with memory 122. Communication device 124 can include features enabling communication between data module 100 and other devices 140 external to cooler 10, such as for the purpose of transmitting information from the memory 122 to the other devices 140.

In some embodiments, the communication device 124 is capable of establishing an internet connection for data module 100. In some such embodiments, data module 100 may be configured to communicate information stored on memory 122 to other devices 140 across the internet connection either periodically or continuously.

In further embodiments, the communication device 124 may be able to join local networks or establish direct electronic communication with other devices 140. For example, in some embodiments, communication device 124 may enable data module 100 to communicate with a portable smart device or other personal electronic device other than through an internet connection. In some such embodiments, communication device 124 may be configured to connect data module 100 to a network, such as a local area network, and to enable data module 100 to transmit information from memory 122 to other devices 140 connected to the network.

In further embodiments, communication device 124 be configured to establish a direct connection with another device 140, such as through a Bluetooth connection or wired connection, and to enable data module 100 to transmit information from memory 122 to the other, directly connected device. In embodiments wherein communication device 124 is configured to connect to the internet, embodiments wherein communication device 124 is configured to connect to other networks, and embodiments wherein communication device 124 is configured to connect directly to other devices 140, communication device 124 may be configured for wireless communication, wired communication, or both wireless and wired communication. In embodiments wherein communication device 124 is configured for wireless communication, communication device 124 may include a wireless transceiver for wireless communication according to any wireless communication standard, such as, for example, Bluetooth, Wi-Fi, near field communication, narrow band internet-of-things, any other wireless internet-of-things protocols, or any other wireless digital communications protocols. In embodiments wherein communication device 124 is configured for wired communication, communication device 124 may include any one or any combination of a cable, a port, and a plug compliant with any physical electronic communication standard, such as, for example, any type of universal serial bus (“USB”) style connector.

Data module 100 of the illustrated embodiment further includes a global positioning system (“GPS”) 128. GPS 128 is in communication with memory 122. Thus, location of cooler 10 can be stored on memory 122 and reported to other devices 140 through communication device 124. Thus, data module 100 can facilitate tracking a location of cooler 10. In other embodiments, GPS 128 can be separate from data module 100. In some such other embodiments, GPS 128 can be installed on cooler 10 outside of data module 100 and placed in electronic communication with memory 122 of data module 100 to facilitate tracking location of cooler 10.

The suite of monitors, sensors, or other data acquisition devices included in data module 100 or installed on cooler 10 to be in communication with data module 100 can be tailored depending on factors such as the type of communication device 124 data module 100 is provided with, the communication infrastructure expected to be available where cooler 10 will be installed, and the expected frequency of data capture from data module 100 expected. For example, if data module 100 includes a communication device 124 capable of internet communication and cooler 10 is to be installed in a location with reliable internet access, memory 122 limitations may be of relatively little concern because data captured by cooler 10 can be communicated across the internet connection continuously or at relatively short intervals. In such applications, cooler 10 can be provided with monitors or sensors configured to acquire relatively large amounts of data. Thus, in some embodiments, data module 100 may include an internet capable communication device 124 and a stock monitoring system for cooler 10 may include one or more cameras 118 configured to monitor stock within storage compartment 11.

In another example, if communication device 124 is not capable of internet communication or cooler 10 is to be installed in a location without reliable internet access, data module 100 may be configured to store data acquired from cooler 10 for relatively long intervals so that a technician may periodically download data from memory 122 to another device 140. In such applications, memory 122 limitations may be of relatively great concern because possible measurements will go unrecorded if memory 122 becomes full between downloads. Thus, in some embodiments, a stock monitoring system for cooler 10 may include one or more load cells 116, but lack any cameras 118 configured to monitor stock within storage compartment. In various embodiments, data module 100 may be configured to collect and store data acquired by sensors installed on cooler 10 for at least one month, at least two months, at least three months, at least four months, at least five months, or at least six months and up to one year.

In another example, if communication device 124 is installed in a location without reliable internet access, the timing for when data is transmitted can be scheduled for times when, e.g., better connectivity is detected, fewer users or active on the relevant network, or the system/network load is known to be lesser. In another example, data module 100 may be configured to dynamically reduce the data richness of recordings as available memory decreases. For example, when available memory falls below a predetermined threshold, data module 100 may cease to record data from cameras 118 while continuing to record data from load cells 116.

Data module 100 can include a processor 136 in communication with memory 122. In some embodiments, processor 136 can be configured for edge computing including processing of information stored on memory 122. In further embodiments, processor 136 can be configured for edge computing including processing of any information acquired by data module 100 and any information communicated to data module 100. Thus, processor 136 can be configured to process information acquired by any one or any combination of traffic monitor 104, door monitor 108, refrigeration system monitor 112, load cells 116, camera 118, and temperature sensor 120.

In some embodiments, processor 136 can be configured to derive conclusions from data acquired by monitors or sensors installed on cooler 10. For example, in some embodiments processor 136 can be configured to derive an estimated number of people that passed near cooler 10 from data acquired by traffic monitor 104. In another example, in some embodiments processor 136 can be configured to derive a number of times door 18 was opened during a given timeframe from data acquired by door monitor 108. In some embodiments, the conclusions derived from data acquired by monitors or sensors installed on cooler can require less memory to store than the data acquired by the monitors or sensors. Thus, processor 136 of some embodiments can contribute to efficient memory 122 usage by deriving conclusions from acquired data and then removing the acquired data from memory 122. Processor 136 can further be configured to store any such derived conclusions on memory 122.

In some embodiments, data module 100 and the associated monitors and sensors, including traffic monitor 104, door monitor 108, refrigeration system monitor 112, load cells 116, camera 118, temperature sensor 120, and GPS 128 may be integrated into cooler 10 during the manufacture of cooler 10. In further embodiments, a conventional cooler can be retrofitted with modifications including, among other things, data module 100 and any of the associated monitors or sensors to become a cooler 10 as described herein.

In some embodiments, data module 100 and any associated monitors and sensors can be provided in a retrofit kit configured to be installed in a preexisting cooler, such as a conventional cooler. Thus, retrofit kits according to various embodiments of the present disclosure can include data module 100 and any one or any combination of traffic monitor 104, door monitor 108, refrigeration system monitor 112, load cells 116, camera 118, temperature sensor 120, and GPS 128. Monitors or sensors within the retrofit kit can be considered a sensor suite of the retrofit kit. Thus, the retrofit kit can include a data module 100 and a sensor suite, wherein the sensor suite includes any one or any combination of traffic monitor 104, door monitor 108, refrigeration system monitor 112, load cells 116, camera 118, temperature sensor 120, and GPS 128. Installing the retrofit kit in a cooler can include installing the sensor suite and installing data module 100 such that data module 100 is configured to store data acquired by sensor suite. A plurality of retrofit kits can be installed in a plurality of coolers to enable aggregation of data from the plurality of coolers. Data from the plurality of coolers can be aggregated by aggregating data stored on the plurality of data modules 100 within the installed plurality of retrofit kits.

The retrofit kit can be installed in a cooler by installing the contents of the retrofit kit as described above with regard to the data module 100, monitors, and sensors of cooler 10. Thus, in some embodiments, installing the retrofit kit on a cooler can include installing load cells 116 to measure load applied to the shelves of the cooler. In further embodiments, installing the retrofit kit on a cooler can include installing camera 118 to obtain image data of a storage compartment of the cooler. In further embodiments, installing the retrofit kit on a cooler can include installing refrigeration system monitor 112 on the cooler such that refrigeration system monitor 112 can monitor activity of the cooler's refrigeration system. Monitoring activity of the cooler's refrigeration system can include monitoring power usage by the refrigeration system or measuring trends in temperature in the cooler's storage compartment. In further embodiments, installing the retrofit kit can include installing door monitor 108 on the cooler such that door monitor 108 can detect when a door of the cooler opens. In further embodiments, installing the retrofit kit can include installing traffic monitor 104 on the cooler such that traffic monitor 104 may detect the presence of people near the cooler. In further embodiments, installing the retrofit kit can include installing data module 100 on the cooler such that data module 100 is in electronic communication with other elements of the retrofit kit installed on the cooler, including any monitors or sensors included in the retrofit kit. In some embodiments, installing data module 100 on the cooler can include replacing a preexisting controller of the cooler with data module 100. For example, applying the retrofit kit to a cooler with a preexisting controller can include removing the preexisting controller from the cooler, then installing data module 100 such that data module 100 can assume some or all control functions previously executed by the preexisting controller. The control functions previously executed by the preexisting controller can be control of the cooler, such as, for example, governing the operation of the cooler's refrigeration system. In further embodiments, installing data module 100 in a cooler can include connecting data module 100 to preexisting sensors in the cooler such that data module 100 can receive information acquired by the preexisting sensors. In some embodiments, the preexisting sensors in the cooler can include some or all sensors that were previously in communication with a controller replaced by the data module 100. Thus, in some embodiments, data module 100 can be configured to execute control functions in the cooler in which data module 100 has been installed.

Information collected by data module 100 from the various monitors and sensors installed on cooler 10 can be used to optimize usage of cooler 10. Usage of cooler 10 that can be optimized can include any one or any combination of operating parameters of refrigeration system 14, schedules for restocking product 30 in cooler 10, maintenance protocols for cooler 10, and planograms for cooler 10. For example, operating parameters of refrigeration system 14 can be optimized for any one or any combination of maximizing energy efficiency, delaying the need for maintenance to refrigeration system 14, and maximizing shelf life of product 30. In some embodiments, schedules for restocking product 30 can be optimized for any one or any combination of preventing product 30 from going out of stock, avoiding instances where product 30 expires before being sold, and maximizing profit to an operator of cooler 10. In some embodiments, optimizing schedules for restocking product 30 can include predicting fluctuations in demand for specific types of product 30 based on variables such as, for example, time of week, time of year, upcoming holidays, upcoming sporting events, or any other time related variable. In further embodiments, optimizing schedules for restocking product 30 can include, after predicting fluctuations in demand for specific types of product 30, adjusting order sizes and timing to avoid running out of stock of high-demand product 30 types or expiration of low-demand product 30 types. In some embodiments, maintenance protocols for cooler 10 can be optimized for any one or any combination of optimal refrigeration system 14 function, minimized cooler 10 downtime, minimized operation expense, minimized power consumption, and maximized capture of data from data module 100. In some embodiments, cooler 10 downtime can be minimized by predicting the occurrence of refrigeration system 14 malfunction based on information acquired by refrigeration system monitor 112 and scheduling maintenance to prevent the predicted malfunction from interrupting usage of cooler 10. In some embodiments, planograms for cooler 10 can be optimized for any one or any combination of maximizing profit to an operator of cooler 10, maximizing conversion rate of foot traffic in the vicinity of cooler 10 to opening door 18, maximizing conversion rate of opening door 18 to removal of product 30 from cooler 10, and maximizing conversion rate of foot traffic in the vicinity of cooler 10 to purchases of product 30. For the purposes of optimization as described herein, an operator of cooler 10 can include any entity that profits when product 30 that has been stocked in cooler 10 is purchased.

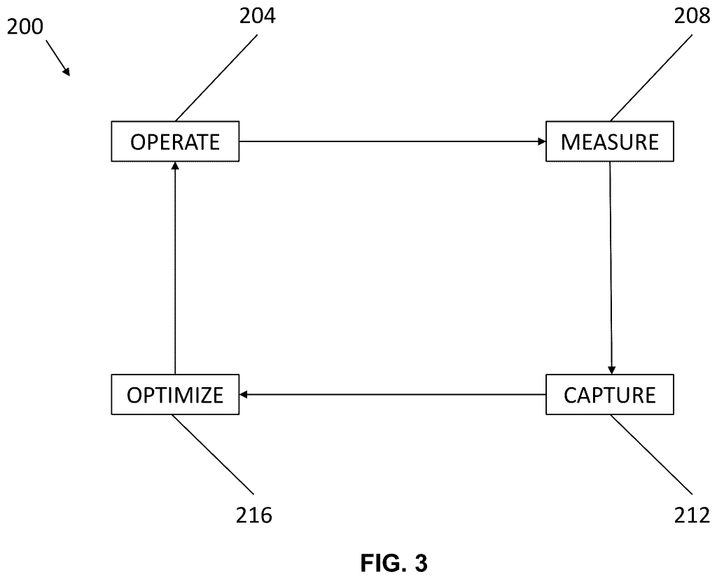

With the optimization of the usage of cooler 10 based on data collected by data module 100, cooler 10 usage can be improved over time as shown in the improvement cycle 200 of FIG. 3. In improvement cycle 200, cooler 10 can be operated within an operate stage 204. A measure stage 208 includes measuring aspects of cooler 10 during the operation of cooler 10, such as by usage of any of the monitors and sensors described herein in connection with data module 100. Thus, measure stage 208 of some embodiments can include, for example, any one or any combination of acquiring measurements related to foot traffic near cooler using traffic monitor 104, acquiring measurements for counting openings of door 18 using door monitor 108, acquiring measurements relating to performance of refrigeration system 14 using either or both of refrigeration system monitor 112 and temperature sensor 120, and acquiring measurements related to stock of product 30 using either or both of load cells 116 and camera 118.

The measurements acquired in measure stage 208 can be collected for analysis at a capture stage 212. Capture stage 212 can include the storage of any information acquired during measure stage 208 on memory 122 of data module 100. In some embodiments, capture stage 212 can include use of communication device 124 of data module 100 to transmit any information from memory 122 of data module 122 to other devices 140 and locations for analysis. In some embodiments, capture stage 212 can include aggregation of information from multiple coolers 10.

Within optimize stage 216, optimizations for cooler 10 usage as described above can be created by the analysis of information collected in measure stage 208. Thus, optimize stage 216 can comprise, for example, optimizing operating parameters of refrigeration system for any one or any combination of maximizing energy efficiency, delaying the need for maintenance to refrigeration system 14, and maximizing shelf life of product 30. In further examples, optimize stage 216 can comprise optimizing schedules for restocking product 30 for any one or any combination of preventing product 30 from going out of stock, avoiding instances where product 30 expires before being sold, and maximizing profit to an operator of cooler 10. In further examples, optimize stage 216 can comprise optimizing maintenance protocols for cooler 10 for any one or any combination of optimal refrigeration system 14 function, minimized cooler 10 downtime, minimized operation expense, minimized power consumption, and maximized capture of data from data module 100. In some embodiments, optimize stage 216 can comprise any of the foregoing optimizations, individually or in any combination. In embodiments wherein more than one factor is sought to be optimized, the optimizations created in optimize stage 216 can comprise creating optimizations to maximize a combined metric that is a function of the multiple factors to be optimized. The combined metric may be positively related to factors to be maximized and negatively related to factors to be minimized. Optimize stage 216 according to some such embodiments may thereby achieve a favorable balance among the multiple, sometimes competing considerations relevant to operating cooler 10.

For example, in some embodiments, shelf life of product 30 and energy efficiency of cooler 10 may both be factors to be optimized. In some such embodiments, a combined metric may be a function of both shelf life of product 30 and energy efficiency of cooler 10. The function may positively relate the combined metric to the shelf life of product 30 and negatively relate the combined metric to energy expenditure by cooler 10. Accordingly, in such embodiments, the combined metric will increase as shelf life of product 30 increases and decrease as energy expenditure by cooler 10 increases. In some such embodiments, optimize stage 216 can comprise creating an optimization to maximize the combined metric, thereby creating an optimal balance of product 30 shelf life and energy efficiency.

The information analyzed within optimize stage 216 can be the information collected within capture stage 212. In some embodiments, optimize stage 216 can include generating improvements to any one or any combination of operating parameters of refrigeration system 14, schedules for restocking product 30 in storage compartment 11, and maintenance protocols for cooler 10 based on analysis of the information collected within capture stage 212. In various embodiments, the generation of optimizations and the analysis of the collected information can be performed by human analysts, computer programs such as, for example, machine learning models, or both. In some embodiments wherein capture stage 212 includes aggregation of information from multiple coolers 10, optimize stage 216 can be conducted based on information aggregated from multiple coolers 10. In some embodiments, optimize stage 216 can include processing of any information to generate conclusions therefrom as described above with regard to the edge computing capabilities possessed in some embodiments by processor 136 of data module 100.

In some embodiments, the optimizations derived in optimize stage 216 can be generated at a remote computing device 140 or location that receives data, directly or indirectly, transmitted from data module 100 during capture stage 212. In some such embodiments, communication device 124 of data module 100 can further be configured to receive some or all such optimizations from the remote computing device 140. Thus, optimize stage 216 can include transmitting optimizations to one or more data modules 100. Remote computing devices 140 herein can include cloud computing systems. In further embodiments, data module 100 may be configured to generate optimizations within optimization stage 216 based on information stored on memory 122. In some embodiments wherein data module 100 acts as a controller for cooler 10, including some embodiments wherein optimizations are generated at a remote computing device 140 and some embodiments wherein optimizations are generated by data module 100, data module 100 can implement optimizations received by communication device 124. For example, in some embodiments, data module 100 may alter operating parameters of refrigeration system 14 in accordance with an optimization of refrigeration system 14 performance generated within optimize stage 216. Thus, in some embodiments, data module 100 can be configured to implement optimizations through the execution of control functions in cooler 10. The control functions can comprise, for example, governing the operation of refrigeration system 14.

In some embodiments, optimize stage 216 can include usage of one or more machine learning models. The machine learning models for this purpose can be machine learning models of any type. Thus, in some embodiments, the one or more machine learning models can include a neural network. In various embodiments, the one or more machine learning models can be configured for supervised learning, unsupervised learning, reinforcement learning, or any combination of supervised, unsupervised, and reinforcement learning. In some embodiments, the machine model's learning can be directed toward any of the optimizations to be created in optimize stage 216, including optimizations of any individual factor or optimization of a combined metric defined as a function of any multiple factors. In some such embodiments, a trained machine learning model can create an optimization during optimize stage by generating a recommendation for operational change that the machine learning model associates with a positive outcome based on its training. In some embodiments, the machine learning model's recommendations made during optimize stage 216 can be output to a human operator to be manually implemented. In further embodiments, the machine learning model's recommendations made during optimize stage 216 can be output directly to a controller, such as data module 100, to be implemented automatically. In further embodiments, the machine learning model's recommendations made during optimize stage 216 can be output directly to a human operator via a computing device, including a mobile device, or other device chosen by the human operator so that it can be implemented automatically, or upon approval of the human operator, depending on operator settings or preferences, which can be changed.

In some embodiments wherein the machine learning model is configured for supervised learning, a human trainer may be tasked with optimizing any factor or metric relevant to cooler 10. The human trainer may create training data by tagging sets of data of the same type as may be acquired during measure stage 208 as being favorable or unfavorable with respect to the factor or metric the human trainer was tasked with optimizing. The machine learning model may be trained on the training data. After being trained on the training data, within optimize stage 216 the machine learning model may create optimizations by recommending changes to any phenomena measured during measure stage 208 that would lead to a favorable outcome based on associations learned from the training data. For example, in some embodiments a human trainer may be tasked with optimizing operation of cooler 10 to delay a need for maintenance to refrigeration system 14. To create training data, the human trainer may tag sample data of measurements of phenomena related to the operation of refrigeration system, such as temperature within a refrigerated space and power consumption, as being favorable or unfavorable to the longevity of components of refrigeration system 14. The machine learning model may be trained on the training data. In some such embodiments, after the machine learning model has been trained on the training data, optimization stage 218 may comprise the machine learning model analyzing information acquired during measure stage 208 and creating optimizations to increase the time remaining before maintenance on refrigeration system 14 becomes necessary based on associations learned from the training data. This process may enable the machine learning model to automatically simulate some of the human trainer's judgment and technical knowledge, thereby improving ease of use for the cooler's 10 operator and reducing interruptions to customers.

In some embodiments wherein the machine learning model is configured for unsupervised learning, the machine learning model may be tasked with optimizing any factor or metric relevant to cooler 10. In some such embodiments, the machine learning model may learn by analyzing data of the same type as may be acquired during measure stage 208 to identify associations between the factor or metric to be optimized and other measured phenomena. Optimize stage 216 may comprise the machine learning model analyzing information acquired during measure stage 208 and creating optimizations for the factor or metric. The machine learning model may create optimizations for the factor or metric by recommending a change to any measured phenomena that the machine learning model associates with an improvement to the factor or metric based on the machine learning model's learning. In some embodiments, the data the machine learning model analyzes for unsupervised learning can comprise data actually acquired during measure stage 208. In some such embodiments, optimize stage 216 can comprise some of the machine learning model's unsupervised learning. The machine learning model may therefore improve by use and generate iteratively better recommendations with repeated learning stages.

In some embodiments wherein the machine learning model is configured for reinforcement learning, the machine learning model may be tasked with optimizing any factor or metric relevant to the cooler 10. The machine learning model may learn by recommending interventions in the form of instructions to a human operator or controller of cooler 10, such as data module, with such instructions comprising a change to an aspect of cooler's 10 operation. The machine learning model may then analyze the data gathered in measure stage 208 after implementation of the intervention to assess the intervention's effect on the factor or metric to be optimized. The machine learning model may then positively reinforce the intervention if the factor or metric moved in desired direction following implementation of the intervention. Further, the machine learning model may negatively reinforce the intervention if the factor or metric did not move in the desired direction following implementation of the intervention. In some such embodiments, the machine learning model may create optimizations for the factor or metric by implementing the interventions in optimize stage 216. Thus, by repeated passes through measure stage 208 and optimize stage 216, the machine learning model may iteratively improve the quality of the interventions it recommends and move closer to optimal operation of cooler 10.

In some embodiments, a machine learning model configured to perform any of the processes of optimize stage 216 can be configured to generate optimizations to the usage of cooler 10 as described above based on data gathered in capture stage 212. In further embodiments, a machine learning model configured to perform any of the processes of optimize stage 216 can be configured to process measurements acquired in measure stage 208 to generate determinations based thereon. In some embodiments, a machine learning model configured to perform any of the processes of optimize stage 216 can be hosted on a remote computing device 140 that receives data, directly or indirectly, transmitted from data module 100 within capture stage 212. In further embodiments, data module 100 can host a machine learning model configured to perform any of the processes of optimize stage 216. In some embodiments, the machine learning model hosted by data module 100 can be stored on memory 122 and operated by processor 136.

Optimizations generated during optimize stage 216 can be implemented within operate stage 204. The extent of any improvements achieved by implementing the optimizations can then be observed by monitoring the continued operation of cooler 10, and further optimizations and refinements can be generated by analyzing the resulting data. Thus, continued operation, monitoring, and optimization of cooler 10 can create a positive feedback loop represented in the improvement cycle 200 that improves cooler 10 performance over time. Such improvements may be realized in customer experience, profitability to retail operators and product 30 manufacturers, and environmental friendliness. The feedback loop represented in improvement cycle 200 can be effective in embodiments wherein optimize stage 216 includes usage of one or more machine learning models, as the one or more machine learning models can be trained on the results achieved by implementation of earlier optimizations. In some embodiments, the one or more machine learning models can be trained on the results achieved by implementation of earlier optimizations to improve the quality of further optimizations generated by the one or more machine learning models.

The stages 204, 208, 212, 216 of improvement cycle 200 are not necessarily sequential, and the processes described above with regard to any of the stages 204, 206, 212, 216 are not necessarily exclusive to any one stage. Thus, processes described above with regard to any of the stages 204, 208, 212, 216 may occur before, after, or during any processes described with respect to any other stage 204, 208, 212, 216. For example, some of the edge computing described above as being within optimize stage 216 can occur before the resulting conclusions are transmitted for further analysis as part of capture stage 212. Moreover, usage and monitoring of cooler 10 within the operate stage 204 and measure stage 208, respectively, can occur continuously while information is transmitted within capture stage 212 and processed within optimize stage 216.

In some embodiments, the data module 100 and associated sensor suite may also facilitate automated detection and diagnosis of malfunction in cooler 10. For example, the same processor responsible for deriving optimizations in optimize stage 216 may also be configured to detect equipment malfunctions from data acquired during measure stage 208 and to report the detected malfunctions to an operator of cooler 10. In some further embodiments, the same processor responsible for deriving optimizations in optimize stage 216 may further be configured to diagnose equipment malfunctions and report the diagnoses to an operator of cooler 10. Thus, in some embodiments, data module 100 may be configured to conduct and report malfunction detection, malfunction diagnosis, or both based on data acquired during measure stage 208. In further embodiments, a remote computing device 140 may be configured to conduct and report malfunction detection, malfunction diagnosis, or both based on data acquired during measure stage 208. In some embodiments, the machine learning model running on either data module 100 or remote computing device 140 may be trained to conduct malfunction detection, malfunction diagnosis, or both based on data acquired during measure stage 208. The machine learning model may be trained for malfunction detection or malfunction diagnosis through supervised learning, unsupervised learning, reinforcement learning, or any combination of supervised, unsupervised, and reinforcement learning.

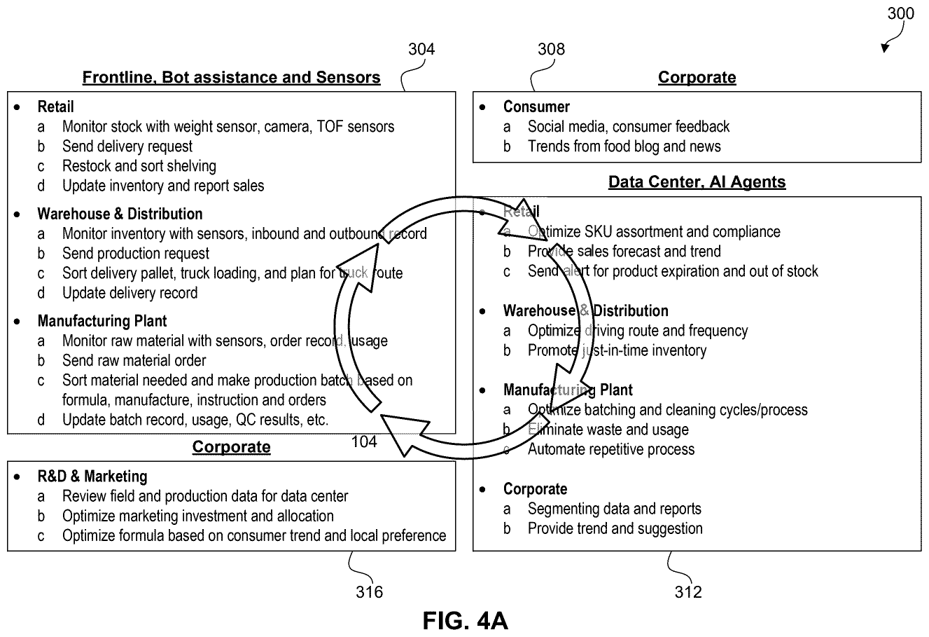

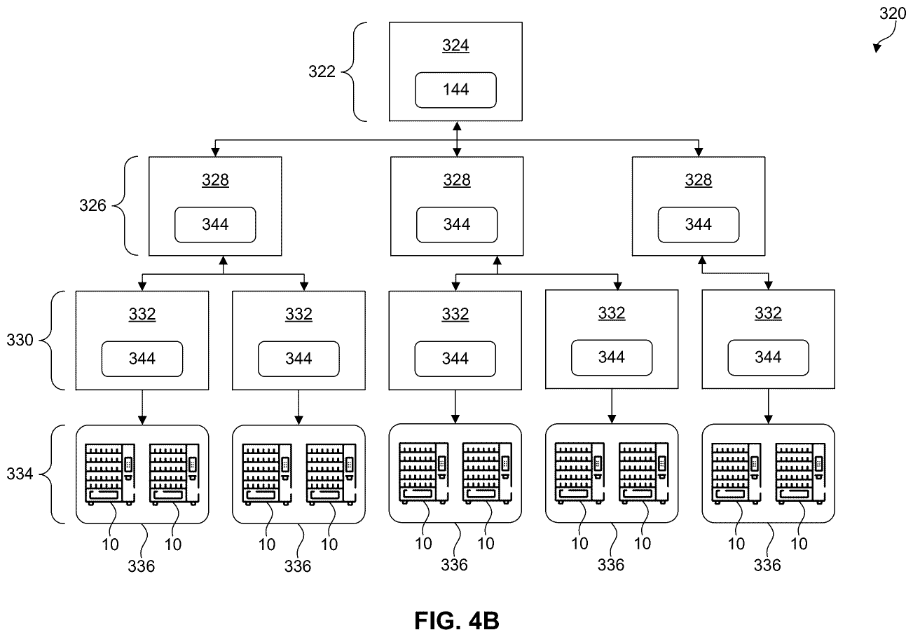

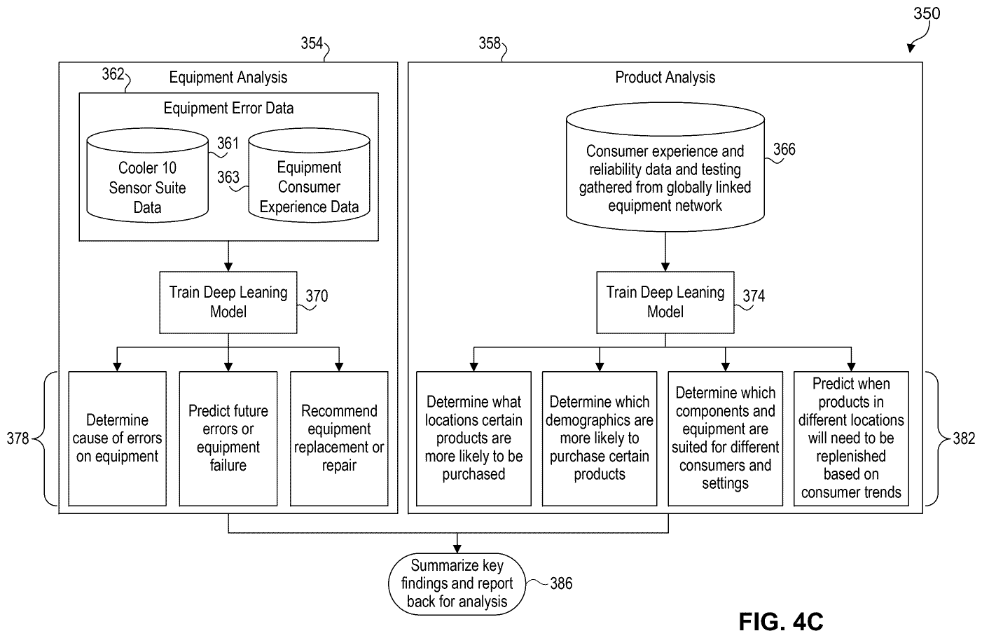

The data module 100 and associated sensor suite can enable cooler 10 to participate in a system 300 for applying machine learning to product manufacture and development as shown in FIG. 4A. System 300 can be alike to systems described in U.S. Ser. No. 18/604,088, filed Mar. 13, 2024, the entirety of which is incorporated herein by reference. In some such embodiments, the information acquired by the sensor suite and reported by data module 100 can be used in a distribution block 304 of system 300. Any machine learning models or processes mentioned herein can, in some examples, be deep learning models. System 300 comprises a distribution block 304 and a reception block 308. Distribution block 304 and reception block 308 each represent multiple possible factors that can be quantified and provided as inputs to Artificial Intelligence (“AI”) Agents block 312. AI Agents block 312 represents one or more machine learning models used to identify associations between any inputs, considered individually or in any combination, and any outputs. System 300 further comprises decision block 316, which represents decisions regarding product manufacture and distribution that can be made in view of outputs from AI Agents block 312. The “blocks” of system 300 refer to groups of processes, subsystems, and devices, and do not necessarily require any particular structure.

Distribution block 304 comprises sensor data and records relating to sales, logistics, and manufacturing. Distribution block 304 can comprise, for example, retail data. Retail data can comprise volume of sales of product 30 from cooler 10 reported by data module 100 to remote computing device 140. Such sales data may be derived from measurements acquired in measure stage 208 or manually input to data module 100 by an operator of cooler 10. Retail data can also include consumer data associated with a purchase and reported by data module 100 to remote computing device 140. An example of said consumer data can be anonymized demographic data, location data, purchase volume data, and the amount spent for a particular product. Such data would only be collected where legal or where a consumer has willingly and knowingly consented to the collection of said data. Such consumer data can also be derived from data collected in measure stage 208 or manually input by consumers or an operator of cooler 10.

Distribution block 304 can further comprise warehouse data. Warehouse data can comprise volume of product movement into and out of a warehouse. A warehouse can be, for example, a location where product is stored before distribution to a retail location. In some examples, warehouse data can be derived from shipment and order records. In further examples, warehouse data can be derived from sensors within an automated inventory monitoring system at the warehouse. An automated inventory monitoring system can comprise sensors configured to measure a quantity of inventory of product at the warehouse. Such sensors can comprise, in various examples, weight sensors configured to measure a weight of product stored on a surface or cameras, such as TOF cameras, configured to measure a space occupied by product. Automated inventory monitoring system can further be configured to request production and delivery of product based on inventory data. For example, automated inventory monitoring system can be configured to request production of a product when inventory of the product falls below a predetermined threshold. In further examples, automated inventory monitoring system can be configured to request production of a product at a rate equal to actual or forecasted rates of inventory leaving the warehouse. The rate of inventory leaving the warehouse can be derived from measurements of inventory quantity acquired with the above mentioned sensors of the automated inventory monitoring system. Warehouse data of distribution block 304 can comprise production requests placed by human operators, production requests placed by automated inventory monitoring systems, or both.

Distribution block 304 can further comprise manufacturing data. Manufacturing data can comprise raw material quantities, raw material usage rates, and production volume. Manufacturing data can further comprise order volume of raw material. Orders for raw material can be placed, in various examples, by human operators, by automated systems for monitoring raw material quantity or raw material usage, or both. In further examples, manufacturing data can comprise quality control data, such as, for example, a proportion of product found to have defects. Manufacturing data can further comprise data such as level of energy consumption associated with a manufacturing location or level of energy consumption associated with the manufacturing of a product. As will be discussed later, such data can be analyzed to predict and recommend the most environmentally friendly logistics, manufacturing, distribution, and sales solutions.

Operations at any of the foregoing sources of information within distribution block 304, including retail locations, warehouses, and factories or other manufacturing facilities, can be conducted with the assistance of machinery, such as robots or other devices. Such machinery can be automated or human operated. In each location, the machinery can be used to move product, materials, or both. For example, at retail locations, machinery can be used to restock shelves. In further examples, at relocations, machinery can be used to sort products within a storage space. In some examples wherein the machinery comprises an automated robot, the robot can cooperate with the automated stock monitoring system to restock product as orders of new stock arrive at the retail location. Similarly, product handling machinery can be used at a warehouse to sort inventory and otherwise move product about the warehouse. The product handling machinery can be used, for example, to unload newly arrived product from a delivery vehicle, load product onto a delivery vehicle to fulfill orders, or both. Such warehouse product handling machinery can be automated product handling machinery. Automated product handling machinery in some embodiments can comprise one or more automated robots. Automated systems can also be used to develop routes for delivery vehicles conveying product to or from the warehouse. Similarly, product handling machinery can be used at a manufacturing facility to transport raw material and product within the facility, unload raw material from a delivery vehicle, load product onto a delivery vehicle, manufacture the product, or any combination of the foregoing.

Any of the above described machinery for use at retail locations, warehouses, or manufacturing facilities can be provided with sensors or any type for monitoring operation of the machinery. For example, the sensors can be configured to take measurements from which product sales, material usage, or both can be derived. The measurements can be comprised by data of distribution block 304 corresponding to the location of the machinery. Thus, retail data can comprise measurements from sensors installed on cooler 10. Warehouse data can similarly comprise measurements from product transportation machinery at warehouses. Manufacturing data can comprise measurements from product or material transportation machinery, measurements from product manufacturing machinery, or both. Additionally or alternatively, the data comprised by distribution block 304 can comprise logs of operations performed by the machinery, instructions given to the machinery, or both.

Reception block 308 comprises information gathered related to public opinion regarding the product or products to which distribution block relates or other products in a related category. Reception block 308 can comprise information acquired by web analytics techniques, such as aggregating discussion of relevant products and concepts from social media, consumer reviews and feedback, blogs, and news. Such aggregated information can be processed to create one or more market insights. The market insights can comprise, for example, whether prevailing attitudes toward a product or product feature are positive or negative, to what degree prevailing attitudes toward a product or product feature are positive or negative, how much certain product types or product features are discussed, what product types or product features are discussed most frequently, or trends concerning any of the foregoing over time.

AI Agents block 312 comprises use of one or more machine learning models to analyze inputs from distribution block 304 and reception block 308 and output operational recommendations. All inputs to AI Agents block 312 can be aggregated into a dataset used to train the one or more machine learning models. AI Agents block can, in some examples, generate operational recommendations concerning order volume and timing from retail locations to warehouses, from warehouses to manufacturing facilities, and from manufacturing facilities to suppliers of raw materials. In further examples, a machine learning model or models of AI Agents block 312 can be configured to generate operational recommendations concerning what thresholds of stock or inventory at retail locations or warehouses should prompt placement of an order for more product and what the volume of the order should be. Such operational recommendations can be optimized to avoid running out of stock at retail locations or inventory at warehouses. In further examples, such recommendations can be optimized to avoid running out of raw material at a manufacturing plant. Recommendations concerning order placement for product at warehouses and order placement for raw materials and rate of manufacture at manufacturing facilities can be coordinated to minimize a chance of order volume from warehouses exceeding the production capacity of manufacturing facilities. Any such operational recommendations can include prospective changes in order volume according to periodic changes in demand discovered from analysis of information provided to the machine learning model(s) of AI Agents block 312. For example, the machine learning model(s) of AI Agents block 312 may recommend greater order volume, higher stock or inventory thresholds below which orders should be placed, or both, in advance of expected weekly or seasonal increases in demand. In further examples, such operational recommendations can be optimized to reduce a likelihood of product remaining unsold until expiring of raw material remaining unused until expiring by reducing order placement volume or frequency in advance of expected weekly or seasonal decreases in demand. In further examples, relative positivity or negativity of any of a variety of factors, such as, for example, total revenue, total sales, total expenses, wasted product, wasted raw materials, demand exceeding production capacity, defective product occurrence frequency, and running out of stock, inventory, and raw materials, can be weighted and provided to the machine learning model(s) of AI Agents block 312, and the machine learning model(s) can be configured to provide operational recommendations expected to result in maximally positive outcomes. Operational recommendations according to any of the foregoing examples can be provided to human operators or pushed to any automated order placement systems associated with retail locations, warehouses, or manufacturing facilities.

The machine learning model(s) of AI Agents block 312 can also be configured to generate operational recommendations meant to provide the most environmentally friendly approach. For example, recycling can be promoted by taking GPS sensor data to determine the location a consumer good will be shipped to. This can be cross-referenced with local regulations identifying which type of packaging can be recycled in that area so that the machine learning models optimize recycling by recommending the use of packaging materials that can recycled in the location it is being shipped to. Similarly, the machine learning model(s) can be used to determine the most fuel-efficient supply chain and logistical solutions by, e.g., recommending: (1) routes that take up the least amount of fuel or recommending supply carriers that utilize hybrid or electric vehicle fleets; and/or (2) delivery schedules that take up the least amount of energy or fuel. Similarly, the machine learning model(s) can recommend manufacturing locations and/or delivery hubs that use the least energy or consume the least water, thereby further reducing the environmental impact associated with delivering products to consumers. Similarly, the machine learning model(s) can create commercial incentives to promote the most environmentally friendly approaches from manufacturing sites, shipping sites, retail sites, warehouses, retailers and consumers. For example, retailers that reach certain recycling goals can be rewarded with discounts, free products, cheaper delivery, earlier access to new products, or being prioritized for popular products or new releases. The machine learning model(s) can also be used to develop or incentivize efficient energy management protocols, such as adjusting a thermostat to a higher setting during closing hours or adjusting the thermostat to a lower setting before regular business hours, such as when sales or production occur. Systems may also be automated to adhere to such energy management protocols. Thus, in some embodiments, facilities can be equipped with controllers governing thermostats to automatically adjust to lower temperatures at closing time and higher temperatures at or before opening time.

The machine learning model(s) of AI Agents block 312 can also be configured to generate operational recommendations for consideration by business professionals, such as individuals involved in corporate governance. Such operational recommendations can concern, for example, long term forecasts for demand for certain product types, trends in consumer sentiment regarding product types or product features, and recommendations for product development. For example, if the machine learning model(s) of AI Agents block 312 determine, from inputs received from reception block 308, that consumer demand for a product type or product feature not offered by the organization operating the machine learning model(s), the machine learning model(s) can recommend developing a product of that type and/or having that feature. Additionally or alternatively, the operational recommendations for consideration by business professionals can comprise recommendations relating to messages to emphasize or avoid in product marketing.

Decision block 316 comprises consideration of the operational recommendations output by the machine learning model(s) of AI Agents block 312 by any human recipients of the operational recommendations. The human recipients comprise, in various examples, engineers, research and development teams, marketing professionals, business professionals, factory operators, vehicle operators, or any other recipients appropriate for the subject matter of the recommendations given. At decision block 316, the human recipients determine which operational recommendations from the machine learning model(s) of AI Agents block 312 to implement and to what extent those recommendations will be implemented. For example, certain product development recommendations may be implemented, whereby new products may be developed and then produced at manufacturing facilities, while other product development recommendations may be ignored or deferred. As another example, steps to reduce power/water consumption and optimize resources in manufacturing, warehousing, retail, and other facilities can be prioritized and implemented based on operational recommendations output by the machine learning model(s). Similarly, logistics related operational recommendations may be implemented throughout the various elements of decision block 304, such as by altering order volumes, order frequencies, delivery routes, workflows in manufacturing facilities, and traffic patterns within storage areas of retail locations, warehouses, and manufacturing facilities. In further examples, certain marketing recommendations may be implemented, such as by adjusting marketing investment across various media, various locations, or both. In still further examples, marketing recommendations can be implemented by developing new marketing campaigns, retiring certain existing marketing campaigns, or both. In some embodiments, a machine learning model or models may be trained to determine which operational recommendations to implement, as discussed above.

Aspects of the above described system 300 can be implemented in an intelligent distribution system 320 as shown in FIG. 4B. Intelligent distribution system 320 can comprise one or more device layers such as a central layer 322, a regional distribution layer 326, an end distribution layer 330, and a retail layer 334. Retail layer 334 can comprise individual retail devices 336. In some embodiments, individual retail devices 336 can be systems or facilities operating a plurality of retail machines, such as for example, coolers 10. It is understood that intelligent distribution system 320 may be implemented with any number of layers and is not limited to the layers depicted in FIG. 4B.

End distribution layer 330 can comprise end distributor devices 332, such as warehouses as described above. End distribution layer 330 includes components and, in some embodiments, facilities, which are configured to distribute product to one or more retailers, which may be represented by retail devices 336. Thus, in some embodiments, each end distributor device 332 can include components, facilities, or both, configured for use in the distribution of product to one or more retailers or retail devices 336. Regional distribution layer 326 can comprise multiple regional distributor devices 328. Regional distribution layer 326 includes components and, in some embodiments, facilities, which are configured to distribute product to one or more end distributor devices 332 within a respective geographic region. Thus, in some embodiments, each regional distributor device 328 can include components, facilities, or both, configured for use in the distribution of product to one or more end distributors or end distributor devices 332. Central layer 322 can comprise a central decision maker device 324, such as a central computer or a cloud computer, configured to aggregate sales and distribution data from regional distributor devices 328.

Intelligent distribution system 320 can comprise a machine learning network distributed across multiple layers of intelligent distribution system 320. For example, the machine learning network can comprise components 344. In some embodiments, each component 344 of the machine learning network can comprise a separate, independently operating machine learning model. In further embodiments, components 344 within regional distribution layer 326 can each be a portion of a collective machine learning machine operating across regional distribution layer 326. In further embodiments, components 344 within end distribution layer 330 can each be or comprise a portion of a collective machine learning model operating across end distribution layer 330. In further embodiments, all components 344 of machine learning model can be or comprise portions of a single machine learning model operating across central layer 322, regional distribution layer 326, and end distribution layer 330 of intelligent distribution system 300. The machine learning model or models according to any of these embodiments can be any type of machine learning model. In some embodiments, each machine learning model can be a neural network.

With respect to the system 300 described above, distribution block 304 can comprise components 344 of the machine learning network within regional distribution layer 326, end distribution layer 330, and retail layer 334. Either or both of AI Agents block 312 and decision block 316 can comprise part or all of the component 344 within central layer 322.

In some embodiments, each regional distributor device 328 can host one or more components 344 of the machine learning network. In some embodiments, each end distributor device 332 can host one or more components 344 of the machine learning network. In some embodiments, the machine learning network can comprise further components 344 within retail layer 334. For example, components 344 within retail layer 334 can be hosted by computer hardware installed within individual retail devices 336. In some embodiments, components 344 can be hosted by computer hardware within individual coolers 10. For example, data modules 100 within coolers 10 can host components 344 of the machine learning network. Thus, in some embodiments, each retail device 336 can host one or more components 344 of the machine learning network.

Components 344 of the distributed machine learning network can be configured to make predictions based on data received from across various portions of the intelligent distribution system 320. Components 344 within different layers 322, 326, 330, 334 can have different roles in the distributed machine learning network. Thus, in some embodiments, each component 344 within end distribution layer 330 can be configured to predict, based on end distributor data comprising distribution records from a respective end distributor device 332 to one or more retail devices 336, future distribution patterns from the end distributor device 332 to the retail devices 336. In some embodiments, each component 344 within end distribution layer 330 can also be configured to optimize distribution practices from the end distributor data for environmental friendliness. The distribution practices can include, for example, distribution routes, distribution schedules, thermostat temperature settings, thermostat schedules, or any combination of the foregoing, and components 344 can be configured to optimize the practices for environmental friendliness by finding solutions that satisfy all necessary criteria (such as timely delivery and avoidance of spoilage) while minimizing energy expenditure or material usage. In some embodiments, the end distributor data can include distribution records from a respective end distribution device 332 to retail devices 336, such as retail facilities. In some embodiments, the end distributor data can include retail data received from the retail devices 336. In some embodiments, the retail data can include records generated by an automated stock monitoring system installed in at least one of the retail devices 336. In some embodiments, retail data can include any one or any combination of sales performance, power usage, machine health, consumer analytic data such as consumer demographics, foot traffic within a retail location or within a predetermined proximity of a cooler 10, conversion rate of new customers, time of sale, location of sale, volume of sale, sale price, and vendor identity or retailer identity. In some embodiments, any or all of the retail data can be acquired through coolers 10. In some embodiments, the end distributor data can further comprise retail data received from the retail devices 336, such as product sales volumes from the retail devices 336. In some embodiments, the retail data can comprise records of product inventory generated by automated inventory monitoring systems installed at one or more of the retail devices 336. In some embodiments, the retail data can include maintenance data from retail devices 336. In some embodiments, the maintenance data from retail devices 336 can include maintenance data from coolers 10. Maintenance data can include records of when coolers 10 fail, what aspects of coolers 10 fail, when repairs are made to coolers, and what repairs are made to coolers 10.

In some embodiments, each component 344 within regional distribution layer 326 can be configured to predict, based on regional distributor data comprising the distribution records from a respective plurality of the end distributor devices 332, future regional sales volume within a geographic region within which the plurality of end distributor devices 332 is located. The regional sales volume can be a volume of sales of products distributed by end distributor devices 332 to retail devices 336. In some embodiments, the distribution records can comprise operation logs from product handling machinery installed in at least one of the end distributor devices 332. In some embodiments, the regional distributor data upon which the component or components 344 of the regional distribution layer 326 can comprise any one or any combination of records of distribution within the geographic region, records of manufacture of products to be distributed within the geographic region, usage rate of materials for manufacture of products to be distributed within the geographic region, inventory of materials to be used in manufacture of products to be distributed within the geographic region, stock of products available to be distributed within the geographic region, records of service calls, records of restock orders, and records of orders to move products. In some embodiments, each component 344 within regional distribution layer 326 can also be configured to optimize distribution practices from the regional distributor data for environmental friendliness. The distribution practices can include, for example, distribution routes, distribution schedules, thermostat temperature settings, thermostat schedules, manufacturing processes, or any combination of the foregoing, and components 344 can be configured to optimize the practices for environmental friendliness by finding solutions that satisfy all necessary criteria (such as fuel efficiency, timely delivery, and avoidance of spoilage) while minimizing energy expenditure or material usage.

In some embodiments, decision maker device 324 can host one or more components 344 of the machine learning network. In some embodiments, the component 344 within central layer 322 can be a central component configured to predict, based on central data comprising the future regional sales volumes predicted by the components 344 within regional distribution layer 326, future global sales volumes of the products distributed by end distributor devices 332 to retail devices 336. In some embodiments, the component 344 within central layer 322 can be a central component further configured to predict, based on the central data, future manufacturing loads necessary to meet the predicted further global sales volumes. This prediction can also be used to optimize an approach to minimize environmental impact while keeping costs down. Thus, in some embodiments, each component 344 within central layer 322 can also be configured to optimize distribution practices from the central data for environmental friendliness. The distribution practices can include, for example, distribution routes, distribution schedules, thermostat temperature settings, thermostat schedules, manufacturing processes, or any combination of the foregoing, and components 344 can be configured to optimize the practices for environmental friendliness by finding solutions that satisfy all necessary criteria (such as fuel efficiency, timely delivery, and avoidance of spoilage) while minimizing energy expenditure or material usage. The component 344 within central layer 322 can also, in some embodiments, create a holistic and traceable record to keep track of green house gas emission to make sure emissions are on track with sustainability goals. In some embodiments, the central component can be partly or entirely comprised by AI Agents block 312 as described above, decision block 316 as described above, or both AI Agents block 312 and decision block 316. Thus, the central data can include any of the information described above as being available to or used by the AI Agents block 312, the decision block 316, or both.

FIG. 3C illustrates an analytic structure 350. In some examples, analytic structure 350 can be a process within AI Agents block 312 of the above described system 300. In further examples, analytic structure 350 can be implemented independently from the above described system 300.

Analytic structure 350 can comprise equipment analysis 354 and product analysis 358. Equipment analysis 354 can be implemented with improvement cycle 200 and data module 100 described above to analyze cooler 10. Equipment analysis 354 begins from receiving input data 362. Input data 362 for equipment analysis 354 can comprise, for example, data 361 acquired by the sensor suite of cooler 10 within measure stage 208 of improvement cycle 200 described above. In some embodiments, input data 362 can also comprise consumer experience data 363. Consumer experience data can comprise any data relating to usage by consumers of the type equipment being analyzed. Consumer experience data 363 can comprise, for example, consumer sentiment and feedback acquired in reception block 308, survey data, data related to measurements of how consumers interact with machines of the type being tested, or any combination of the foregoing.

Equipment analysis 354 comprises a training step 370 wherein input data 362 is used to train a machine learning model. The machine learning model can, in some embodiments, be the same machine learning model used to derive optimizations within optimize stage 216 of improvement cycle. The machine learning model is trained to produce outputs 378 from input data 362. Outputs 378 of equipment analysis 354 can comprise or be comprised by the operational recommendations described above with regard to AI Agents block 312 of system 300. Outputs 378 of equipment analysis 354 can comprise, for example, identified causes of failures of the type of equipment being analyzed, predictions of future error and failure patterns for the type of equipment being analyzed, recommended maintenance, such as replacement or repair, of existing instances of the type of equipment being analyzed, or any combination of the foregoing. In further embodiments, outputs 378 of equipment analysis 354 can comprise any of the optimizations derived in optimize stage 216 of improvement cycle 200 as described above.

Product analysis 358 comprises using product data 366 to train a machine learning model in a training step 374 of product analysis 358. The machine learning model can be, in some examples, a deep learning model. Product data 366 can comprise sales data of a product, usage data of equipment consumers may use to purchase the product, consumer sentiment and feedback acquired in reception block 308, survey data, and reliability data of equipment consumers may use to purchase the product.

In training step 374 of product analysis 358, the machine learning model is trained to produce outputs 382 from product data 366. Outputs 382 of product analysis 358 can comprise or be comprised by the operational recommendations described above with regard to AI Agents block 312 of system 300. Outputs 382 of product analysis 358 can comprise, for example, predictions of locations where certain products are likely to be purchased, identifications of demographics associated with groups of consumers that purchase certain products, predictions which types of equipment are suitable for which consumers and settings, predictions of which locations are likely to run out of stock and require restocking, or any combination of the foregoing.

Analytic structure 350 terminates at report step 386. At report step 386, all or some portion of outputs 378, 382 of equipment analysis 354 and product analysis 358 can be reported to decision makers. Decision makers for this purpose can, in some examples, be any of the human recipients described above with regard to decision block 316 of system 300. Report step 386 can include identification of key findings within outputs 378, 382 or otherwise summarizing or abbreviating outputs 378, 382 before reporting outputs 378, 382 to the decision makers.

It is to be appreciated that the Detailed Description section, and not the Summary and Abstract sections, is intended to be used to interpret the claims. The Summary and Abstract sections may set forth one or more but not all exemplary embodiments of the present disclosure but are not intended to limit the present disclosure and claims in any way.

The foregoing description of the specific embodiments so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the claims and their equivalents.

1. A method of retrofitting a cooler, the method comprising:
installing a sensor suite on the cooler, wherein the sensor suite comprises at least one selected from a group consisting of:
a refrigeration system monitor configured to monitor power usage by a refrigeration system of the cooler,
a traffic monitor configured to detect presence of individuals in a vicinity of the cooler, and
a stock monitoring system; and
installing a data module on the cooler, wherein the data module is configured to store data acquired by the sensor suite.

2. The method of claim 1, wherein the sensor suite comprises a traffic monitor, and the traffic monitor comprises a radio frequency sensor.

3. The method of claim 1, wherein the sensor suite comprises a stock monitoring system, and the stock monitoring system comprises load cells.

4. The method of claim 3, wherein installing the sensor suite comprises configuring the load cells to measure load applied to shelves of the cooler.

5. The method of claim 1, wherein installing the data module comprises replacing a preexisting controller of the cooler with the data module.

6. The method of claim 5, wherein replacing the preexisting controller of the cooler with the data module comprises configuring the data module to assume control functions previously executed by the controller in the cooler.

7. A method of optimizing usage of coolers, the method comprising:
retrofitting multiple coolers according to the method of claim 1;
aggregating data stored on multiple of the data modules installed during the retrofitting of the multiple coolers;
deriving an optimization for the coolers from the aggregated data, wherein the optimization includes at least one of optimizing operating parameters of refrigeration systems of the coolers to maximize energy efficiency, optimizing schedules for restocking product in the coolers to maximize profit, and optimizing maintenance protocols for the coolers to minimize downtime of the coolers.

8. The method of claim 7, comprising transmitting the optimization to at least one of the data modules.

9. The method of claim 8, wherein the at least one of the data modules is configured to execute control functions in at least one of the coolers.

10. The method of claim 9, wherein the at least one of the data modules is configured to alter operating parameters of the refrigeration system of the at least one of the coolers in accordance with the optimization.

11. The method of claim 7, wherein the optimization includes an optimization of a planogram for the coolers to maximize a conversion rate of foot traffic in the vicinity of one of coolers to removal of product from the one of the coolers.

12. A cooler retrofit kit comprising:
a sensor suite comprising at least two selected from a group consisting of:
a refrigeration system monitor configured to monitor power usage by a refrigeration system of the cooler,
a traffic monitor configured to detect presence of individuals in a vicinity of the cooler, and
a stock monitoring system; and
a data module configured to store data acquired by the sensor suite.

13. The cooler retrofit kit of claim 12, wherein the data module is configured to assume control functions of the cooler.

14. The cooler retrofit kit of claim 12, wherein the sensor suite comprises the stock monitoring system and the stock monitoring system comprises load cells.

15. The cooler retrofit kit of claim 12, wherein the data module hosts a machine learning model configured to derive an optimization for usage of the cooler from data acquired from by the sensor suite.

16. The cooler retrofit kit of claim 15, wherein the optimization includes an optimization of a planogram for the coolers to maximize a conversion rate of foot traffic in the vicinity of one of coolers to removal of product from the one of the coolers.

17. A cooler comprising:
a sensor suite comprising:
a traffic monitor configured to detect presence of individuals in a vicinity of the cooler, and
a stock monitoring system; and
a data module configured to store data acquired by the sensor suite and to execute control functions in the cooler.

18. The cooler of claim 17, wherein the data module hosts a machine learning model configured to derive an optimization for usage of the cooler from data acquired from by the sensor suite.

19. The cooler of claim 17, configured to transmit the data acquired by the sensor suite to a remote device, receive optimizations from the remote device, and implement the optimizations through the execution of the control functions.

20. The cooler of claim 17, comprising a refrigerated storage compartment and shelves located within the storage compartment, wherein the stock monitoring system comprises load cells configured to measure load on the shelves.
